(19) United States
(12) Patent Application Publication
(10) Pub. No.: US 2026/0115885 A1
(43) Pub. Date: Apr. 30, 2026

(54) ROD CONNECTION STRUCTURE AND MOP ROD USING SAME

(71) Applicant: CIXI BOSHENG PLASTIC CO., LTD., Cixi (CN)

(72) Inventor: Zhenghui HUANG, Cixi (CN)

(73) Assignee: CIXI BOSHENG PLASTIC CO., LTD., Cixi (CN)

(21) Appl. No.: 19/023,563

(22) Filed: Jan. 16, 2025

(30) Foreign Application Priority Data
Oct. 31, 2024 (CN) 202411540044.3

(51) Int. Cl. B25G 3/30; A47L 13/20

(52) U.S. Cl. CPC B25G 3/30; A47L 13/20

(57) ABSTRACT

A rod connection structure includes a rod body, where the rod body includes a first rod body and a second rod body; a lower end of the first rod body is provided with a hollow space; the hollow space forms an opening on an end surface of the lower end of the first rod body; one end of the second rod body is provided with an insertion portion; the insertion portion of the second rod body is inserted into the hollow space of the first rod body through the opening at the lower end of the first rod body, such that the second rod body is connected to the first rod body; the first rod body is a metal rod body; and an edge of the opening of the first rod body extends outward to form an outer protrusion. A mop rod includes the above-mentioned rod connection structure.

### CROSS REFERENCE TO THE RELATED APPLICATIONS

This application claims priority based on Chinese patent application No. 202411540044.3 filed on Oct. 31, 2024, the entire contents of which are hereby incorporated by reference.

### TECHNICAL FIELD

The present disclosure relates to a rod connection structure.

### BACKGROUND

The rod body of a mop rod, a broom, or a dustpan, etc. usually includes a first rod body and a second rod body. The lower end of the first rod is provided with a hollow space, which forms an opening on the end surface of the lower end of the first rod body. One end of the second rod body is provided with an insertion portion. The insertion portion of the second rod body is inserted into the hollow space of the first rod body through the opening at the lower end of the first rod body. In this way, the second rod body is connected to the first rod body.

However, existing rod bodies have the following shortcomings: due to the opening formed at the lower end of the first rod body, the rod body is prone to damage at the opening when it is subjected to a force.

### SUMMARY

In order to overcome the above-mentioned shortcoming of the existing rod member, the present disclosure provides a rod connection structure with a longer service life.

In order to solve the technical problem, the present disclosure adopts the following technical solutions. A rod connection structure includes a rod body, where the rod body includes a first rod body and a second rod body; a lower end of the first rod body is provided with a hollow space; and the hollow space forms an opening on an end surface of the lower end of the first rod body;

one end of the second rod body is provided with an insertion portion; and the insertion portion of the second rod body is inserted into the hollow space of the first rod body through the opening at the lower end of the first rod body, such that the second rod body is connected to the first rod body; and

the first rod body is a metal rod body; and an edge of the opening of the first rod body extends outward to form an outer protrusion.

Further, the first rod body is formed by rolling a metal sheet and welding the metal sheet at a joint; and a weld seam is formed at the joint;
the second rod body includes a body portion, a joint portion, and the insertion portion; the insertion portion is connected to one end of the body portion through the joint portion; and a diameter of the insertion portion is at least smaller than a diameter of the body portion connected to the joint portion; and
the outer protrusion is a rolled edge formed by the sheet at the edge of the opening of the first rod body by at least extending outward from the weld seam; and the rolled edge is provided with a curved surface.

Further, the curved surface of the rolled edge of the first rod body abuts against an outer surface of the joint portion of the second rod body.

Further, a tail end of the rolled edge is rolled over a highest endpoint of the rolled edge.

Further, the rolled edge is a circle of rolled edge formed by extending the sheet at the edge of the opening of the first rod body outward; and the circle of rolled edge completely or partially abuts against the joint portion.

Further, the rolled edge is rolled into a ring with a circular or elliptical cross-section.

Further, the joint portion is provided with an inclined contact wall; and the curved surface of the rolled edge abuts against an outer surface of the contact wall.

Further, the contact wall is concave and curved; and alternatively, the outer wall is inclined and flat.

Further, the second rod body is detachably connected to the first rod body.

Further, the hollow space of the first rod body is provided therein with a first connector; and alternatively, a side wall of the hollow space of the first rod body is provided with the first connector;
the insertion portion of the second rod body is fixedly connected to a second connector; and alternatively, the insertion portion of the second rod body is provided with the second connector; and
the second connector is connected to the first connector, such that the second rod body is connected to the first rod body.

Further, the first connector is a screw sleeve with an internal thread; the second connector is a screw head with an external thread; the external thread is adapted to the internal thread; and when the first rod body is connected to the second rod body, the screw head is screwed into the screw sleeve.

Further, the body portion, the joint portion, and the insertion portion of the second rod body are integrated; and/or the second rod body is a metal rod body formed by rolling a sheet and welding the sheet at a joint.

A mop rod includes the above-mentioned rod connection structure.

The present disclosure has the following beneficial effects. The edge of the opening of the first rod body extends outward to form the outer protrusion. The outer protrusion enhances the strength of the opening, making it less likely for the first rod body to be damaged at the opening, thereby extending the service life of the rod.

### BRIEF DESCRIPTION OF THE DRAWINGS

FIG. 1 is a structural diagram of a mop rod according to the present disclosure;

FIG. 2 is an exploded view of the mop rod according to the present disclosure;

FIG. 3 is an exploded view of the mop rod from another perspective according to the present disclosure;

FIG. 4 is a section view of a connection point between a first rod body and a second rod body;

FIG. 5 is a detail of A shown in FIG. 4;

FIG. 6 is a schematic diagram showing another surface contact form between an outer protrusion and a joint surface;

FIG. 7 is a schematic diagram showing another surface contact form between the outer protrusion and the joint surface;

FIG. 8 is a schematic diagram showing another surface contact form between the outer protrusion and the joint surface;

FIG. 9 is a schematic diagram showing another surface contact form between the outer protrusion and the joint surface; and

FIG. 10 is a schematic diagram showing another surface contact form between the outer protrusion and the joint surface.

### DETAILED DESCRIPTION OF THE EMBODIMENTS

The present disclosure is described in further detail below with reference to the drawings and specific implementations.

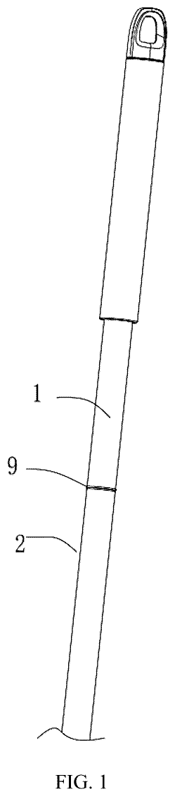

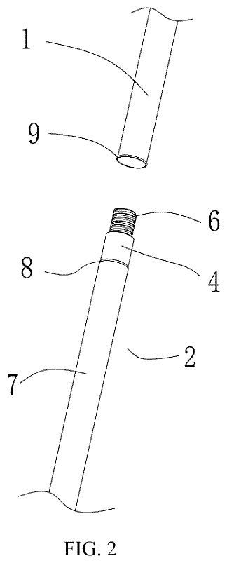

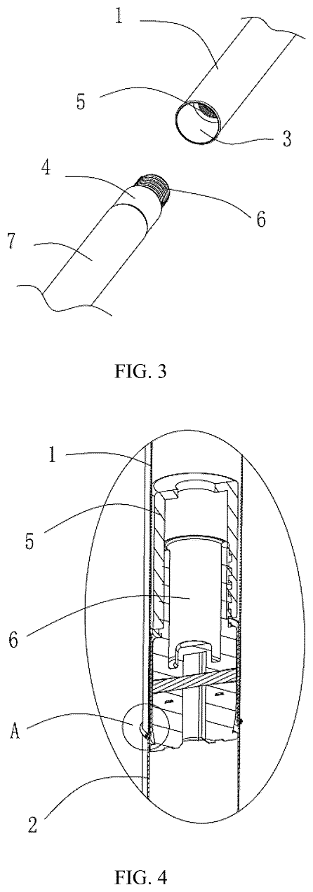

As shown in FIGS. 1 to 10, a rod connection structure includes a rod body. The rod body includes first rod body 1 and second rod body 2. Generally speaking, the first rod body 1 and the second rod body 2 are made of a metal material, but they can also be made of a non-metal material. When the first rod body 1 and the second rod body 2 are made of a metal material, in order to facilitate molding and save costs, the first rod body 1 and the second rod body 2 can be molded in the following way. The first rod body 1 and the second rod body 2 each are formed by rolling a metal sheet and welding the metal sheet at a joint, where a weld seam is formed at the joint.

A lower end of the first rod body 1 is provided with hollow space 3. The hollow space 3 forms an opening on an end surface of the lower end of the first rod body 1. When the first rod body 1 is formed by rolling a metal sheet and welding the metal sheet at a joint, naturally, the hollow space 3 and the opening are formed at the lower end of the first rod body 1. One end of the second rod body 2 is provided with insertion portion 4. The insertion portion of the second rod body 2 is inserted into the hollow space 3 of the first rod body 1 through the opening at the lower end of the first rod body 1, such that the second rod body 2 is connected to the first rod body 1. An edge of the opening of the first rod body 1 extends outward to form an outer protrusion. The outer protrusion enhances the strength of the opening, making it less likely for the first rod body 1 to be damaged at the opening, thereby extending the service life of the rod.

In an embodiment, the hollow space of the first rod body 1 is provided therein with a first connector. The insertion portion 4 of the second rod body 2 is fixedly connected to a second connector. The second connector is connected to the first connector, such that the second rod body 2 is connected to the first rod body 1. In order to facilitate the disassembly and assembly of the first rod body 1 and the second rod body 2, the second rod body 2 is detachably connected to the first rod body 1. In a detachable connection method, the first connector includes screw sleeve 5 with an internal thread, and the second connector is specifically screw head 6 with an external thread. The external thread is adapted to the internal thread. When the first rod body 1 is connected to the second rod body 2, the screw head 6 is screwed into the screw sleeve 5. Of course, other methods can also be used for the first connector and the second connector. For example, the first connector is a connecting sleeve with a wedge groove inside, and the second connector is a wedge head with a wedge element adapted to the wedge groove. When the first rod body and the second rod body are connected, the wedge element is inserted into the wedge groove until the outer protrusion comes into contact with a joint surface.

Of course, the first connector can also be formed on a side wall of the hollow space 3 of the first rod body 1. That is, the first connector is formed in the hollow space 3 of the first rod body, rather than a separate component. The second connector can also be formed on the insertion portion 4, rather than a separate component. For example, the first connector is a thread formed on the side wall of the hollow space 3 of the first rod body, and the second connector is a thread formed on the insertion portion 4 and adapted to the thread on the side wall of the hollow space.

In an embodiment, the second rod body 2 includes body portion 7, joint portion 8, and the insertion portion 4. The insertion portion 4 is connected to one end of the body portion 7 through the joint portion 8. A diameter of the insertion portion 6 is at least smaller than a diameter of the body portion connected to the joint portion 8. That is, the diameter of the body portion connected to the joint portion 8 is larger than a diameter of the insertion portion 4, and the diameter of other parts of the body portion is smaller, greater, or equal to the diameter of the insertion portion. Generally speaking, the body portion 7, the joint portion 8, and the insertion portion 4 of the second rod body are integrated. The outer protrusion is rolled edge 9 formed by the sheet at the edge of the opening of the first rod body 1 by at least extending outward from the weld seam. The rolled edge 9 is provided with a curved surface. The curved surface of the rolled edge 9 of the first rod body 1 abuts against an outer surface of the joint portion 8 of the second rod body 2. That is, the first rod body is connected to the second rod body until the curved surface of the rolled edge 9 of the first rod body comes into contact with the outer surface of the joint portion 8 of the second rod body. The so-called rolled edge is formed by the sheet at the edge of the opening of the first rod body, which not only extends outward, but also curls inward in the direction of the first rod body 1.

In the above structure, especially, the first rod body 1 and the second rod body 2 each are formed by rolling a metal sheet and welding the metal sheet at a joint, where a weld seam is formed at the joint. Generally speaking, rods, such as mop rod, broom rod, and dustpan rod, are metal rods. For these household cleaning products, the cost of using seamless metal pipes is too high. The method of forming the rod body by rolling the metal sheet and welding the metal sheet at the joint can save costs. But this type of rod body has a major problem. Due to the fact that the first rod body 1 and the second rod body 1 are welded pipes formed by rolling and welding, the stress concentrates in the weld seam. When in use, there is an external force pressing or acting on the rod body. Under the external force (especially when the mop or broom rod is in use, the rod body is pressed, resulting in a particularly large external force on the rod body), the stress further concentrates at the contact position between the first rod body and the second rod body. Since the side wall at the opening of the first rod body is basically linear, it is hard to effectively disperse the stress. As a result, it is easy to cause a rupture at the end of the weld seam of the first rod body. Once a rupture appears at the end of the weld seam, the weld seam is easily torn apart when an operation continues. In addition, under the external force, the opening of the first rod body is prone to deformation and expansion. Based on these two reasons, the service life of the rod is relatively short, and after a period of use, there will be a large gap at the connection between the first rod body and the second rod body, which will cause loosening.

To solve the problem existing in the prior art, a plastic sleeve is provided between the first rod body and the second rod body. However, due to the soft and easily deformed plastic of the plastic sleeve, the plastic sleeve can only alleviate the damage or deformation problem at the lower end of the first rod body, but cannot effectively solve this problem.

The technical solution of the present disclosure also faces the problem of stress concentration in the weld seam. However, the weld seam at the opening on the lower end of the first rod body is provided with the rolled edge 9 that extends outward. The curved surface of the rolled edge 9 abuts against the joint portion 8, relatively increasing the contact area. Therefore, when there is an external force applied to the rod body, it can effectively disperse the stress and prevent the end of the weld seam at the lower end of the first rod body from being ruptured. The rolled edge 9 that extends outward also enhances the strength of the weld seam, further increasing the difficulty of tearing. In addition, the contact between the curved surface of the rolled edge 9 and the joint surface of the joint portion 8 increases the contact area relatively and increases the friction force. Therefore, the first rod body 1 and the second rod body 2 are easier to lock and less likely to loosen. Based on the above beneficial effects, there is no need to provide the plastic sleeve between the first rod body 1 and the second rod body 2.

In an embodiment, the rolled edge 9 is a circle of rolled edge formed by extending the sheet at the edge of the opening of the first rod body outward. This circle of rolled edge completely or partially abuts against the joint portion. The edge of the opening of the first rod body 1 extends outward as a whole to form the rolled edge 9, making it easy to form the rolled edge 9. In addition, this circle of rolled edge 9 enhances the strength of the opening, making the opening less likely to deform and the weld seam less likely to tear. Of course, multiple rolled edges extending outward can also be formed by the sheet at the edge of the opening of the first rod body 1, and the multiple rolled edges are separated and not connected to each other.

In an embodiment, a tail end of the rolled edge 9 is rolled over a highest endpoint of the rolled edge 9, that is, the tail end of the rolled edge 9 is hidden inside the rolled edge 9, and will not be touched by the operator. The significance of this structure is as follows. In the prior art, the metal sheet at the opening of the first rod body 1 will form a relatively sharp cutting edge, making it easy for the operator to be scratched by the cutting edge. This is also one of the reasons why a plastic sleeve is sometimes provided between the first rod body 1 and the second rod body 2 in the prior art. After the tail end of the rolled edge 9 is rolled over the highest endpoint of the rolled edge, the tail end of the rolled edge 9 is hidden inside the rolled edge 9 and will not be touched by the operator, avoiding the operator from being scratched by the cutting edge. Therefore, there is no need to provide a plastic sleeve between the first rod body 1 and the second rod body 2.

In an embodiment, as shown in FIGS. 4, 5, 6, and 7, the rolled edge 9 is rolled into a ring with a circular or elliptical cross-section. In terms of craftsmanship, compared to other shapes, the ring with a circular or elliptical cross-section formed by rolling the opening at the lower end of the first rod body 1 outward is basically the simplest. In addition, the circular or elliptical ring is not angular, making it easier to disperse stress. Of course, the circular cross-section here refers to a cross-section that is essentially circular, not necessarily an absolute perfect circle. The elliptical cross-section here refers to a cross-section that is essentially elliptical, not necessarily an absolute ellipse.

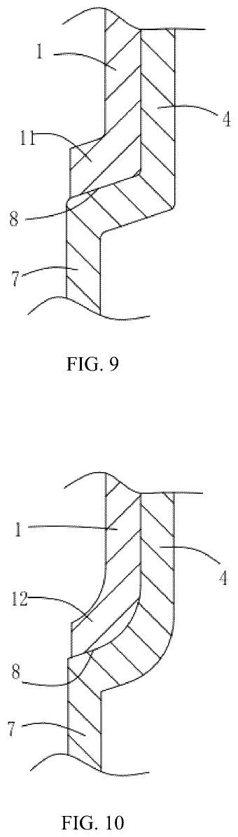

Of course, the outer protrusion extending outward at the opening on the lower end of the first rod body 1 can also take other forms. For example, in FIG. 8, the outer protrusion is right-angled flange 10 that extends outward. Alternatively, as shown in FIG. 9, the outer protrusion is inclined flat flange 11 that extends outward. Alternatively, as shown in FIG. 10, the outer protrusion is curved flange 12 that extends outward.

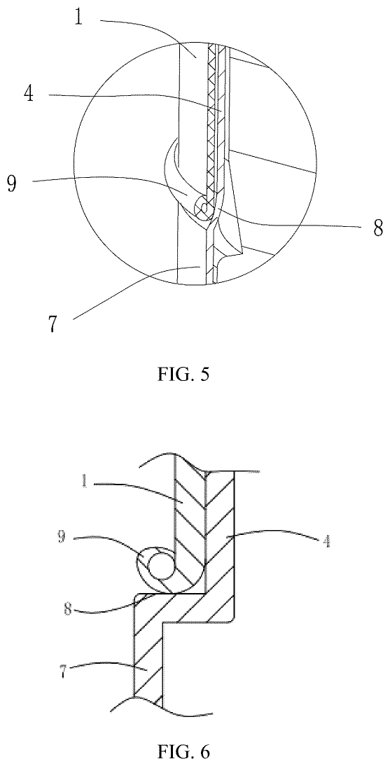

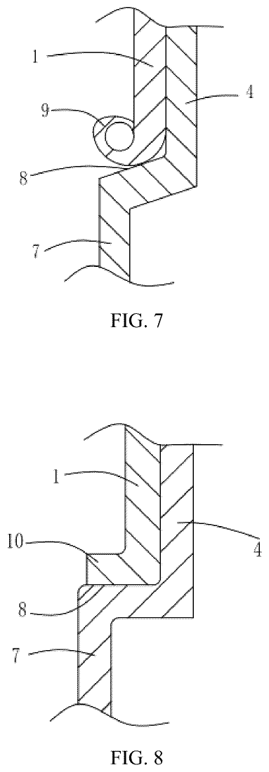

In an embodiment, the joint portion 8 is provided with an inclined contact wall. The curved surface of the rolled edge 9 abuts against the outer surface of the contact wall. The inclined contact wall facilitates the integrated molding of the body portion 7, the joint portion 8, and the insertion portion 4, and increases the contact area between the rolled edge 9 and the contact wall. Preferably, the contact wall is concave and curved. For example, in FIGS. 4 and 5, the rolled edge 9 is a ring with a basically circular cross-section, and the contact wall of the joint portion 8 is concave and curved. The curved surface of the ring-shaped rolled edge forms a large contact area with the concave curved surface. As shown in FIG. 7, the rolled edge 9 is a ring with a basically circular cross-section, and the contact wall of the joint portion 8 is inclined and flat located on an outer wall of the second rod body 2. The curved surface of the ring-shaped rolled edge forms a large contact area with the inclined flat surface. As shown in FIG. 9, the outer protrusion is the inclined flat flange 11 that extends outward, and the contact wall of the joint portion 8 is the inclined flat surface located on the outer wall of the second rod body. The inclined flat flange 11 forms a large contact area with the contact wall of the inclined flat surface. In FIG. 10, the outer protrusion is the curved flange 12 that extends outward, and the contact wall of the joint portion 8 is a concave curved slope. The curved flange 12 forms a large contact area with the concave curved slope.

Of course, the joint portion 8 can also take other forms. As shown in FIG. 6, the rolled edge 9 is a ring with a basically circular cross-section, and the joint portion 8 is a horizontal radial step surface that connects the insertion portion with the rest of the second rod body. The curved surface of the ring-shaped rolled edge forms a large contact area with the horizontal step surface. As shown in FIG. 8, the outer protrusion is the right-angled flange 10 that extends outward, and the joint portion 8 is a horizontal radial step surface that connects the insertion portion with the rest of the second rod body. The right-angled flange forms a large contact area with the horizontal step surface.

The above rod connection structure can be applied to a rod, such as a mop rod, a broom rod, and a dustpan rod; and the rod, such as the mop rod, the broom rod, and the dustpan rod includes the above-mentioned rod connection structure.

In the specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. In the specification, the schematic representations of the above terms do not necessarily refer to the same embodiment or example. In addition, the specific features, structures, materials, or characteristics described may be combined in any suitable manner in any one or more embodiments or examples.

The above illustrates the implementation of the present disclosure. However, the present disclosure is not limited to the above-mentioned implementation. Any modifications, equivalent substitutions, improvements, etc. made within the spirit and scope of the present disclosure should be included within the protection scope of the present disclosure.

1. A rod connection structure, comprising a rod body, wherein the rod body comprises a first rod body and a second rod body; a lower end of the first rod body is provided with a hollow space; and the hollow space forms an opening on an end surface of the lower end of the first rod body;
one end of the second rod body is provided with an insertion portion; and the insertion portion of the second rod body is inserted into the hollow space of the first rod body through the opening at the lower end of the first rod body, thereby connecting the second rod body to the first rod body; and
the first rod body is a metal rod body; and an edge of the opening of the first rod body extends outward to form an outer protrusion.

2. The rod connection structure according to claim 1, wherein the first rod body is formed by rolling a metal sheet and welding the metal sheet at a joint; and a weld seam is formed at the joint;
the second rod body comprises a body portion, a joint portion, and the insertion portion; the insertion portion is connected to one end of the body portion through the joint portion; and a diameter of the insertion portion is at least smaller than a diameter of the body portion connected to the joint portion; and
the outer protrusion is a rolled edge formed by the metal sheet at the edge of the opening of the first rod body by at least extending outward from the weld seam; and the rolled edge is provided with a curved surface.

3. The rod connection structure according to claim 2, wherein the curved surface of the rolled edge of the first rod body abuts against an outer surface of the joint portion of the second rod body.

4. The rod connection structure according to claim 3, wherein a tail end of the rolled edge is rolled over a highest endpoint of the rolled edge.

5. The rod connection structure according to claim 3, wherein the rolled edge is a circle of rolled edge formed by extending the metal sheet at the edge of the opening of the first rod body outward; and the circle of rolled edge completely or partially abuts against the joint portion.

6. The rod connection structure according to claim 5, wherein the rolled edge is rolled into a ring with a circular or elliptical cross-section.

7. The rod connection structure according to claim 3, wherein the joint portion is provided with an inclined contact wall; and the curved surface of the rolled edge abuts against an outer surface of the contact wall.

8. The rod connection structure according to claim 7, wherein the contact wall is concave and curved; and alternatively, the contact wall is inclined and flat.

9. The rod connection structure according to claim 1, wherein the second rod body is detachably connected to the first rod body.

10. The rod connection structure according to claim 9, wherein a first connector is provided in the hollow space of the first rod body; and alternatively, a side wall of the hollow space of the first rod body is provided with the first connector;
the insertion portion of the second rod body is fixedly connected to a second connector; and alternatively, the second connector is formed on the insertion portion of the second rod body; and
the second connector is connected to the first connector, thereby connecting the second rod body to the first rod body.

11. The rod connection structure according to claim 10, wherein the first connector is a screw sleeve with an internal thread; the second connector is a screw head with an external thread; the external thread is adapted to the internal thread; and when the first rod body is connected to the second rod body, the screw head is screwed into the screw sleeve.

12. The rod connection structure according to claim 1, wherein the body portion, the joint portion, and the insertion portion of the second rod body are integrated as a whole; and/or
the second rod body is a metal rod body formed by rolling a sheet and welding the sheet at a joint.

13. A mop rod, comprising the rod connection structure according to claim 1.

14. The rod connection structure according to claim 4, wherein the joint portion is provided with an inclined contact wall; and the curved surface of the rolled edge abuts against an outer surface of the contact wall.

15. The rod connection structure according to claim 5, wherein the joint portion is provided with an inclined contact wall; and the curved surface of the rolled edge abuts against an outer surface of the contact wall.

16. The mop rod according to claim 13, wherein the first rod body is formed by rolling a metal sheet and welding the metal sheet at a joint; and a weld seam is formed at the joint;
the second rod body comprises a body portion, a joint portion, and the insertion portion; the insertion portion is connected to one end of the body portion through the joint portion; and a diameter of the insertion portion is at least smaller than a diameter of the body portion connected to the joint portion; and
the outer protrusion is a rolled edge formed by the metal sheet at the edge of the opening of the first rod body by at least extending outward from the weld seam; and the rolled edge is provided with a curved surface.

17. The mop rod according to claim 16, wherein the curved surface of the rolled edge of the first rod body abuts against an outer surface of the joint portion of the second rod body.

18. The mop rod according to claim 17, wherein a tail end of the rolled edge is rolled over a highest endpoint of the rolled edge.

19. The mop rod according to claim 17, wherein the rolled edge is a circle of rolled edge formed by extending the metal sheet at the edge of the opening of the first rod body outward; and the circle of rolled edge completely or partially abuts against the joint portion.

20. The mop rod according to claim 19, wherein the rolled edge is rolled into a ring with a circular or elliptical cross-section.
